(19) United States
(12) Patent Application Publication
(10) Pub. No.: US 2007/0211257 A1
(43) Pub. Date: Sep. 13, 2007

(54) Fabry-Perot Interferometer Composite and Method

(76) Inventors: Daniel A. Kearl, Corvallis, OR (US); Michael G. Monroe, Corvallis, OR (US); Henry Lewis, Corvallis, OR (US); Melinda Valencia, Corvallis, OR (US); James C. McKinnell, Corvallis, OR (US); James R. Przybyla, Corvallis, OR (US); Arthur Piehl, Corvallis, OR (US); Stephen J. Potochnik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/276,676

(22) Filed: Mar. 9, 2006

(51) Int. Cl. G01B 9/02

(52) U.S. Cl. 356/519

(57) ABSTRACT

A composite partially reflecting element of a Fabry-Perot interferometer includes a transparent plate having a surface facing toward the optical gap of the interferometer, a partially reflecting layer disposed on the surface of the transparent plate facing toward the optical gap, and at least one protective layer on at least one side of the partially reflecting layer.

### CROSS-REFERENCE TO RELATED APPLICATIONS

This application is related to co-pending and commonly assigned application Ser. No. 10/428261 (attorney docket no. 10016895-1) filed Apr. 30, 2003; application Ser. No. 11/233045, (attorney docket no. 200504684-1) and application Ser. No. 11/233225, (attorney docket no. 200503982-1), both filed Sep. 21, 2005; application Ser. No. 11/238704 (attorney docket no. 200310614-2) filed Sep. 29, 2005; provisional application Ser. No. 60/619,380 (attorney docket no. 200310614-1) filed Oct. 14, 2004; and application Ser. No. 11/284225 (attorney docket no. 200406434-1) filed Nov. 21, 2005, the entire disclosure of each of which is incorporated herein by reference.

### TECHNICAL FIELD

This invention relates generally to Fabry-Perot interferometer device structures and methods.

### BACKGROUND

There are many applications for light modulator devices that have high spatial and time resolution and high brightness, including applications in displays of information for education, business, science, technology, health, sports, and entertainment. Some light modulator devices, such as digital light-mirror arrays and deformographic displays, have been applied for large-screen projection. For white light, light modulators such as the reflective digital mirror arrays have been developed with high optical efficiency, high fill-factors with resultant low pixelation, convenient electronic driving requirements, and thermal robustness.

Macroscopic scanners have employed mirrors moved by electromagnetic actuators such as “voice-coils” and associated drivers. Micro-mirror devices have used micro-actuators based on micro-electro-mechanical-system (MEMS) techniques. MEMS actuators have also been employed in other applications such as micro-motors, micro-switches, and valves for control of fluid flow. Micro-actuators have been formed on insulators or other substrates using micro-electronic techniques such as photolithography, vapor deposition, and etching.

A micro-mirror device can be operated as a light modulator for amplitude and/or phase modulation of incident light. One application of a micro-mirror device is in a display system. In such a system, multiple micro-mirror devices are arranged in an array such that each micro-mirror device provides one cell or pixel of the display. A conventional micro-mirror device includes an electrostatically actuated mirror supported for rotation about an axis of the mirror into either one of two stable positions. Thus, such a construction serves to provide both light and dark pixel elements corresponding to the two stable positions. For gray scale variation, binary pulse-width modulation has been applied to the tilt of each micro-mirror. Thus, conventional micro-mirror devices have frequently required a high frequency oscillation of the mirror and frequent switching of the mirror position and thus had need for high frequency circuits to drive the mirror. Binary pulse-width modulation has been accomplished by off-chip electronics, controlling on- or off-chip drivers.

Conventional micro-mirror devices must be sufficiently sized to permit rotation of the mirror relative to a supporting structure. Increasing the size of the micro-mirror device, however, reduces resolution of the display since fewer micro-mirror devices can occupy a given area. In addition, applied energies must be sufficient to generate a desired force needed to change the mirror position. Also, there are applications of micro-mirror devices that require positioning of the mirror in a continuous manner by application of an analog signal rather than requiring binary digital positioning controlled by a digital signal. Accordingly, it is desirable to minimize the size of a micro-mirror device so as to maximize the density of an array of such devices, and it is desirable as well to provide means for positioning the micro-mirror device in an analog fashion.

Micro-electromechanical systems (MEMS) are systems which are typically developed using thin film technology and include both electrical and micro-mechanical components. MEMS devices are used in a variety of applications such as optical display systems, pressure sensors, flow sensors, and charge-control actuators. MEMS devices of some types use electrostatic force or energy to move or monitor the movement of micro-mechanical electrodes, which can store charge. In one type of MEMS device, to achieve a desired result, a gap distance between elements is controlled by balancing an electrostatic force and a mechanical restoring force.

MEMS devices designed to perform optical functions (sometimes called micro-optical-electromechanical systems or MOEMS devices) have been developed using a variety of approaches. According to one approach, a deformable deflective membrane is positioned over an electrode and is electrostatically attracted to the electrode. Other approaches use flaps or beams of silicon or aluminum, which form a top conducting layer. For such optical applications, the conducting layer is reflective while the deflective membrane is deformed using electrostatic force to direct light which is incident upon the conducting layer.

More specifically, MEMS of a type called optical interference devices produce colors based on the precise spacing of a pixel plate relative to a lower plate (and possibly an upper plate). This spacing may be the result of a balance of two forces: electrostatic attraction based on voltage and charge on the plate(s), and a spring constant of one or more “support structures” maintaining the position of the pixel plate away from the electrostatically charged plate. Embodiments of such devices have included Fabry-Perot device structures. In the fabrication of such devices, partially reflective surfaces may be formed, but such partially reflective surfaces may be subject to degradation of their properties, either in their use environment of the devices or in the processes used to fabricate the light modulator devices. Stability of optical properties is especially important for maintaining consistent and reliable performance of Fabry-Perot devices, especially for tunable Fabry-Perot devices intended to include a “dark” or “off” state in their applications. Thus, while various light modulator devices have found widespread success in their applications, there are still unmet needs in the field of micro-optical light modulator devices.

### BRIEF DESCRIPTION OF THE DRAWINGS

The features and advantages of the disclosure will readily be appreciated by persons skilled in the art from the following detailed description when read in conjunction with the drawings, wherein:

FIG. 1 is a cross-sectional elevation view of an embodiment of a Fabry-Perot interferometer structure.

FIG. 2 is a cross-sectional elevation view of an embodiment of a Fabry-Perot interferometer structure with electrical connections shown schematically.

FIG. 3 is a flow chart of an embodiment of a method for fabricating an embodiment of a Fabry-Perot interferometer structure.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting.

The term “cermet” is used in the present specification and the appended claims. A cermet is a composite material composed of ceramic and metallic materials, as often used in the manufacture of components which may experience high temperatures. The metal may be used with an oxide, boride, carbide, nitride, or alumina, for example. The metallic elements used may be nickel, molybdenum, and/or cobalt, for example. Other metals are included hereinbelow. Depending on the physical structure of the materials, cermets may also be formed as metal matrix composites.

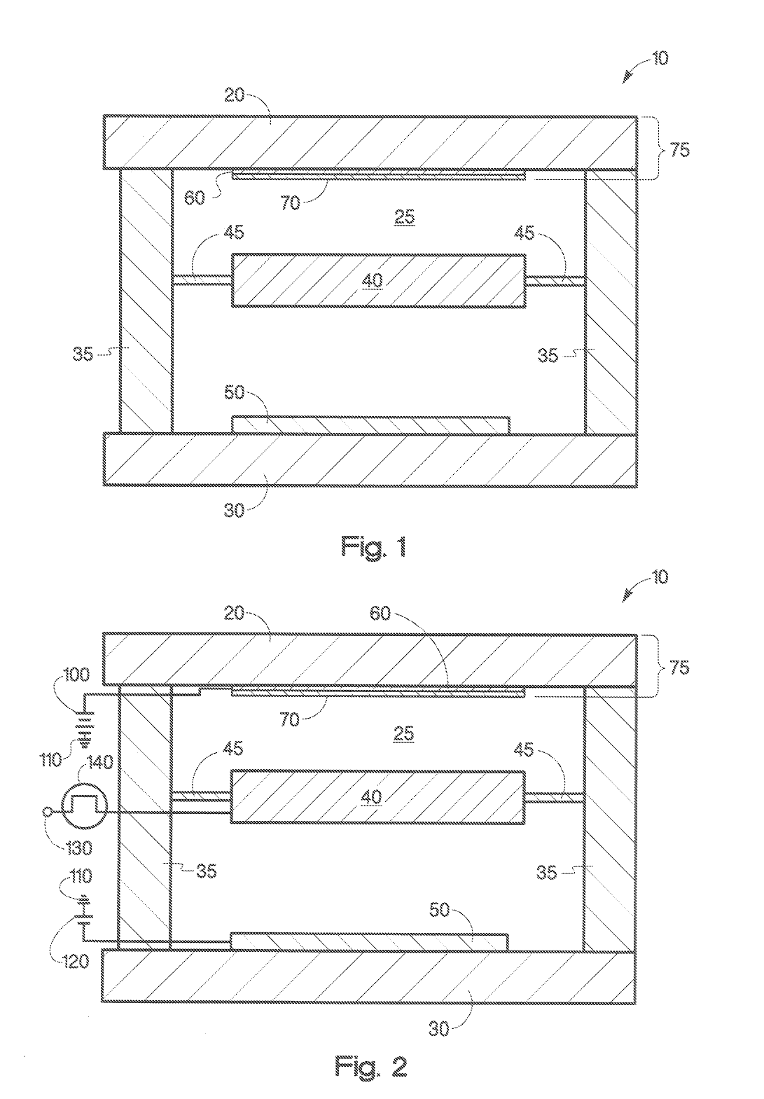

One aspect of the present disclosure provides embodiments of a Fabry-Perot interferometer structure 10 as illustrated in FIGS. 1 and 2. FIG. 1 is a cross-sectional elevation view of an embodiment of a Fabry-Perot interferometer structure. FIG. 2 is a cross-sectional elevation view of such an embodiment with electrical connections shown schematically.

In the Fabry-Perot embodiment shown in FIG. 1, a transparent plate 20 is spaced apart from a substrate 30 by supports 35. Substrate 30 has at least an insulating surface. Substrate 30 may also have full functionality of digital and/or analog circuitry, such as CMOS circuitry. A movable reflective pixel plate 40 is supported in the space between substrate 30 and transparent plate 20 by flexural elements 45. An electrode 50 on substrate 30 serves as a plate of a capacitor. An optical gap 25 between transparent plate 20 and reflective pixel plate 40 may be varied by applying an electrical signal to reflective pixel plate 40, which serves as another plate of the capacitor with electrode 50. A partially reflecting layer 60 allows both partial transmission of light through transparent plate 20 and partial reflection of light reflected back from pixel plate 40. A protective layer 70 covers and protects at least the bottom side of partially reflecting layer 60. The structural embodiment shown in FIG. 1 may be made by employing MEMS fabrication techniques.

In FIG. 2, a voltage source 100 is shown connected between partially reflecting layer 60 and ground 110. A second voltage source 120 is shown connected between electrode 50 and ground 110. Thus, partially reflecting layer 60 and electrode 50 may generally be biased at different potentials. In use of the device, a modulating electrical signal is applied to movable reflective pixel plate 40 at input terminal 130, through a transistor 140. Resultant movement of pixel plate 40 varies optical gap 25 in accordance with the applied signal. The embodiment illustrated in FIGS. 1 and 2 provides an electronically tunable MEMS Fabry-Perot filter.

Thus, a composite partially reflecting element of a Fabry-Perot interferometer includes a transparent plate 20 having a surface facing toward the optical gap 25 of the interferometer, a partially reflecting layer 60 disposed on the surface of the transparent plate facing toward the optical gap 25, and at least one protective layer 70 on at least one side of the partially reflecting layer. The protective layer 70 is generally not an anti-reflection layer.

A particular aspect of the disclosure provides an embodiment of a composite partially reflecting element 75 of a Fabry-Perot interferometer 10 having an optical gap. The Fabry-Perot interferometer embodiment may include a composite partially reflecting element embodiment 75 including a transparent plate having a surface facing toward the optical gap 25, a partially reflecting layer 60 disposed on the surface of the transparent plate facing toward the optical gap, and at least one protective layer 70 on at least one side of the partially reflecting layer. The protective layer 70 may be on the side of the partially reflecting layer that faces toward the optical gap 25, for example. Another protective layer 70 (not shown), of the same or different type, may be disposed on the side of the partially reflecting layer that faces away from the optical gap 25, i.e., the side facing partially reflecting layer 60, for example.

The protective layer 70 is effective to prevent degradation of the partially reflecting layer, preserving at least the partially reflective property of the partially reflecting layer. For example, the protective layer 70 is effective to prevent degradation due to oxidation of the partially reflecting layer. It is also effective to prevent degradation due to reaction with process materials. Specifically, the protective layer is effective to prevent degradation of the composite partially reflecting element 75 due to exposure to process materials which may include a sacrificial material and a process gas used for removal of the sacrificial material. The protective layer 70 of the composite partially reflecting element 75 may also be effective as a diffusion barrier, thus preventing deleterious reactants from adversely affecting optical properties of partially reflecting layer 60.

In specific embodiments, the composite partially reflecting element 75 may have a non-zero extinction coefficient k between about 0.2 and about 2, the value of k being substantially constant with wavelength over a desired wavelength range. The desired wavelength range may include the visible spectrum, for example, for display applications and other applications. In this or other embodiments, the composite partially reflecting element 75 may have a composite refractive index n between about 1.5 and about 4, where n increases substantially monotonically with wavelength over a desired wavelength range. Again, this desired wavelength range may include the visible spectrum. The composite refractive index n is the overall effective refractive index of the composite partially reflecting element 75 as a unit, as if the composite partially reflecting element 75 consisted of a single material of uniform refractive index n.

The partially reflecting layer 60 may include a material such as a metal, a cermet, Ag, Al, Au, Cr, Nb, Ta, Zr, the noble metals, TaAl, chromium oxide, tantalum aluminum oxide, tantalum silicon nitride, tantalum nitride, titanium nitride, alloys of these materials, or combinations of these materials. The thickness of the partially reflecting layer 60 may be between about 1 nanometer and about 50 nanometers, for example. The thickness of partially reflecting layer 60 is chosen to produce a desired reflectance, i.e., to provide the required performance of the Fabry-Perot device. A suitable thickness for some embodiments is about 10 nanometers.

The protective layer 70 may include an oxide, nitride, or oxynitride material such as aluminum oxide, aluminum nitride, hafnium oxide, hafnium silicon oxide, tantalum aluminum nitride, tantalum aluminum oxide, silicon monoxide, silicon dioxide, silicon nitride, silicon oxynitride, silicon oxide doped with phosphorus and/or boron, titanium oxide, a tantalum oxide, zirconia, yttria, yttrium-doped zirconia, a transparent conductor such as indium tin oxide, indium oxide, tin oxide, tin oxide doped with fluorine, or various combinations of these substances. The thickness of the protective layer 70 may be between about 2 nanometers and about 25 nanometers, for example. The thickness of protective layer 70 is chosen to provide the required performance of the Fabry-Perot device while protecting partially reflecting layer 60. This thickness may be greater than 25 nanometers for dielectric protective layers, for example, when extinction coefficient k is very low.

Thus, various embodiments of a composite partially reflecting element 75 of a Fabry-Perot interferometer have portions performing the functions of a transparent plate having a surface facing toward the optical gap, of partially reflecting light, and of protecting and preserving at least the partially reflective property.

Another aspect of the invention is an embodiment of a method including steps of providing a transparent plate, depositing a thin film of metal or cermet to form a partially reflective layer on one side of the transparent plate, and depositing over at least the partially reflective layer a protective layer effective to preserve at least the partially reflective property of the partially reflecting layer. Thus, a composite partially reflecting element 75 for a Fabry-Perot interferometer is formed. A complete Fabry-Perot interferometer including the composite partially reflecting element 75 thus formed is another aspect of embodiments described herein.

A specific embodiment of a method for a Fabry-Perot interferometer having an optical gap includes steps of (a) providing a transparent plate disposed with a surface facing toward the optical gap, (b) providing a thin film of metal or cermet to form a partially reflective layer on the surface of the transparent plate facing toward the optical gap, and (c) providing a protective layer effective to preserve at least the partially reflective property of the partially reflecting layer, whereby a protected partially reflecting composite element 75 is provided. In this specific embodiment, the materials and thicknesses of the thin film and protective layer are selected such that the composite element 75 has a non-zero extinction coefficient k between about 0.2 and about 2, the value of k being substantially constant with wavelength over a desired wavelength range. The materials and thicknesses of the thin film and protective layer are also selected such that the composite element 75 has a composite refractive index n, between about 1.5 and about 4, wherein n increases substantially monotonically with wavelength over the desired wavelength range.

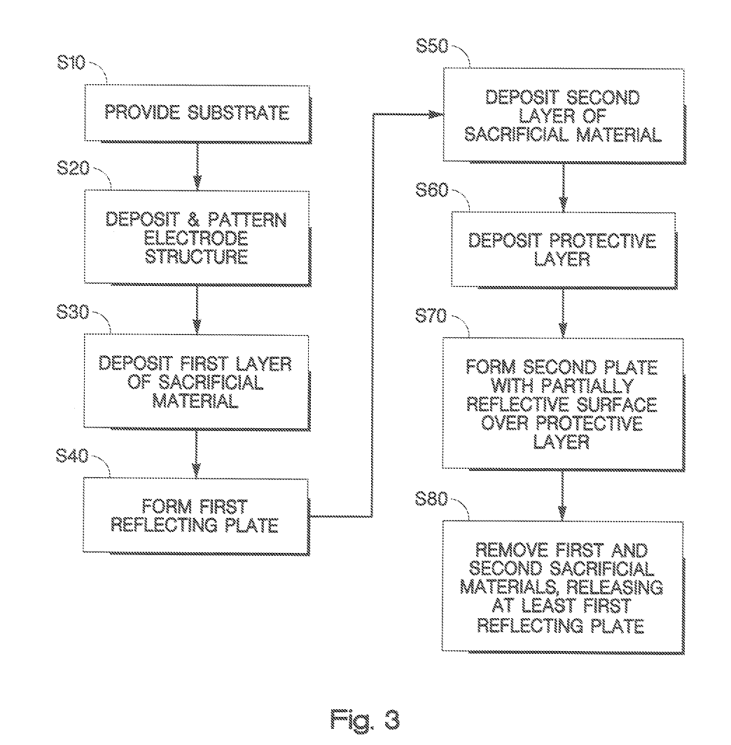

FIG. 3 is a flow chart illustrating an embodiment of a method for making a light modulator. This method embodiment includes a number of steps, including providing a substrate having at least an insulating surface (step S10) and depositing and patterning a conductive electrode structure on the insulating surface (step S20). A first layer of sacrificial material is deposited (step S30). A first reflecting plate having a reflective surface is formed (step S40), and a second layer of sacrificial material is deposited (step S50). A protective layer effective to preserve at least the partially reflective property of a partially reflecting surface is deposited over the second layer of sacrificial material (step S60). A second reflecting plate having the partially reflective surface is formed (step S70) on the protective layer. The first and second layers of sacrificial material are removed to release at least the first reflecting plate while preserving at least the partially reflective property of the partially reflecting surface (step S80).

The substrate 30 may be a silicon wafer with a planar insulating surface, e.g., of silicon oxide. As mentioned above, substrate 30 may also have full functionality of digital and/or analog circuitry, such as CMOS circuitry. Other planar insulating surfaces may be used. Conductive electrode 50 may be a film of metal deposited and patterned by photolithography, for example, on the insulating surface of substrate 30. The reflecting plate 40, its supports 35, and its flexural support elements 45 may include a conductive metallic material. Reflecting plate 40 and its flexural support elements 45 may be deposited and patterned on the first layer of sacrificial material. Suitable sacrificial materials for both the first and second layers of sacrificial material include amorphous silicon, polyimide, photoresist, or any of a number of other sacrificial materials such as those known to those skilled in MEMS fabrication. Each of the layers of sacrificial material may be planarized after depositing the layer, e.g., by chemical-mechanical polishing (CMP). Etchants suitable for removal of each of the sacrificial materials are also known to those skilled in MEMS fabrication. Such etchants are among those process materials to be protected against by protective layer 70.

The material compositions of partially reflective layer 60 and protective layer 70 respectively are described hereinabove. Protective layer 70 may be deposited by any of a number of techniques, including but not limited to sputtering, reactive sputtering, atomic layer deposition, plasma-enhanced atomic layer deposition, plasma-enhanced chemical vapor deposition, metal-organic chemical vapor deposition, and anodization of deposited metallic films. Partially reflective layer 60 may also be deposited by any of these techniques or others, while controlling thickness to provide the desired relative amounts of reflection and transmission, e.g., about 50% reflection and 50% transmission. Deposition conditions for pure metals should be controlled to create relatively low density films, having a degree of “dielectric character” believed to result from this low density. For example, when using sputter deposition, higher-than-usual pressures and low deposition rates (achieved by low power) tend to create such desirable low density films. Thus, the deposition conditions are controlled to provide the desired values for extinction coefficient k and for effective composite refractive index n, as described in more detail hereinabove.

### INDUSTRIAL APPLICABILITY

Device embodiments made in accordance with the invention are useful in display devices that have high spatial and time resolution, high brightness, and a range of colors, with low-power driving requirements. They may also be used in imaging systems such as projectors and in instrumentation applications.

Although the foregoing has been a description and illustration of specific embodiments of the invention, various modifications and changes thereto can be made by persons skilled in the art without departing from the scope and spirit of the invention as defined by the following claims. For example, the reflective layer, the partially reflective layer, and/or the protective layer may include multiple sublayers. Also, the order of process steps may be varied. For example, protective layer 70 may be deposited in step S60 after removing the sacrificial layers in step S80, and/or step S60 may be repeated if protective layers are used on both sides of partially reflecting layer 60.

What is claimed is:

1. A composite partially reflecting element of a Fabry-Perot interferometer having an optical gap, comprising:
a) a transparent plate having a surface facing toward the optical gap,
b) a partially reflecting layer disposed on the surface of the transparent plate facing toward the optical gap, and
c) at least one protective layer on at least one side of the partially reflecting layer.

2. The composite partially reflecting element of claim 1, wherein the at least one protective layer is effective to prevent degradation of the partially reflecting layer due to oxidation of the partially reflecting layer and to prevent degradation due to reaction with process materials, preserving at least the partially reflective property of the partially reflecting layer.

3. The composite partially reflecting element of claim 2, wherein the process materials include a sacrificial material and a process gas used for removal of the sacrificial material.

4. The composite partially reflecting element of claim 2, wherein the at least one protective layer is effective as a diffusion barrier.

5. The composite partially reflecting element of claim 1, wherein the composite element has a non-zero extinction coefficient k between about 0.2 and about 2, the value of k being substantially constant with wavelength over a desired wavelength range.

6. The composite partially reflecting element of claim 5, wherein the desired wavelength range includes the visible spectrum.

7. The composite partially reflecting element of claim 1, wherein the composite element has a composite refractive index n between about 1.5 and about 4, and wherein n increases substantially monotonically with wavelength over a desired wavelength range.

8. The composite partially reflecting element of claim 7, wherein the desired wavelength range includes the visible spectrum.

9. The composite partially reflecting element of claim 1, wherein the partially reflecting layer comprises a material selected from the list consisting of a metal, a cermet, Ag, Al, Au, Cr, Nb, Ta, Zr, the noble metals, TaAl, chromium oxide, tantalum aluminum oxide, tantalum silicon nitride, tantalum nitride, titanium nitride, alloys thereof, and combinations thereof.

10. The composite partially reflecting element of claim 1, wherein the partially reflecting layer comprises a layer having a thickness between about 1 nanometer and about 50 nanometers.

11. The composite partially reflecting element of claim 10, wherein the partially reflecting layer comprises a layer having a thickness of about 10 nanometers.

12. The composite partially reflecting element of claim 1, wherein the at least one protective layer comprises an oxide, nitride, or oxynitride material selected from the list consisting of aluminum oxide, aluminum nitride, hafnium oxide, hafnium silicon oxide, tantalum aluminum nitride, tantalum aluminum oxide, silicon monoxide, silicon dioxide, silicon nitride, silicon oxynitride, silicon oxide doped with phosphorus and/or boron, titanium oxide, a tantalum oxide, zirconia, yttria, yttrium-doped zirconia, a transparent conductor, indium tin oxide, indium oxide, tin oxide, tin oxide doped with fluorine, and combinations thereof.

13. The composite partially reflecting element of claim 1, wherein the at least one protective layer comprises a layer having a thickness between about 2 nanometers and about 25 nanometers.

14. A Fabry-Perot interferometer comprising the composite partially reflecting element of claim 1.

15. A composite partially reflecting element of a Fabry-Perot interferometer having an optical gap, comprising:
a) a transparent plate having a surface facing toward the optical gap,
b) means for partially reflecting light, disposed on the surface of the transparent plate facing toward the optical gap, and
c) means for protecting the means for partially reflecting light while preserving at least the partially reflective property of the means for partially reflecting light.

16. A method comprising steps of:
a) providing a transparent plate,
b) depositing a thin film of metal or cermet to form a partially reflective layer on one side of the transparent plate, and
c) depositing over at least the partially reflective layer a protective layer effective to preserve at least the partially reflective property of the partially reflecting layer, whereby a composite partially reflecting element for a Fabry-Perot interferometer is formed.

17. A composite partially reflecting element for a Fabry-Perot interferometer, formed by the method of claim 16.

18. A Fabry-Perot interferometer comprising the composite partially reflecting element of claim 17.

19. A method for a Fabry-Perot interferometer having an optical gap, the method comprising steps of:
a) providing a transparent plate disposed with a surface facing toward the optical gap,
b) providing a thin film of metal or cermet to form a partially reflective layer on the surface of the transparent plate facing toward the optical gap, and
c) providing a protective layer effective to preserve at least the partially reflective property of the partially reflecting layer, whereby a protected partially reflecting composite element is provided, the materials and thicknesses of the thin film and protective layer being selected such that the composite element has a non-zero extinction coefficient k between about 0.2 and about 2, k being substantially constant with wavelength over a desired wavelength range and such that the composite element has a composite refractive index n, between about 1.5 and about 4, wherein n increases substantially monotonically with wavelength over the desired wavelength range.

20. A method for making a light modulator, comprising:
a) providing a substrate having at least an insulating surface,
b) depositing and patterning a conductive electrode structure on the insulating surface,
c) depositing a first layer of sacrificial material,
d) forming a first reflecting plate having a reflective surface,
e) depositing a second layer of sacrificial material,
f) depositing over the second layer of sacrificial material a protective layer effective to preserve at least the partially reflective property of a partially reflecting surface,
g) forming a second reflecting plate having the partially reflective surface, and
h) removing the first and second layers of sacrificial material to release at least the first reflecting plate while preserving at least the partially reflective property of the partially reflecting surface.
